(19) United States
(12) Patent Application Publication
(10) Pub. No.: US 2025/0272773 A1
(43) Pub. Date: Aug. 28, 2025

(54) COMPUTER-IMPLEMENTED METHOD FOR ENHANCED NEGOTIATION SKILL DEVELOPMENT IN AN AI-POWERED VIRTUAL ENVIRONMENT

(71) Applicant: EARL FITZHUGH, SOUTH ORANGE, NJ (US)

(72) Inventor: EARL FITZHUGH, SOUTH ORANGE, NJ (US)

(21) Appl. No.: 18/589,023

(22) Filed: Feb. 27, 2024

(51) Int. Cl. G06Q 50/18; G06Q 50/20

(52) U.S. Cl. CPC G06Q 50/188; G06Q 50/2057

(57) ABSTRACT

The disclosed invention presents a comprehensive computer-implemented method for honing negotiation skills and optimizing value in an AI-powered virtual environment. Encompassing steps such as providing access, simulating behavior through an AI-powered agent, and implementing data security measures, the method integrates diverse features, including visually immersive interfaces, industry-specific scenarios, and continuous learning mechanisms, to offer a sophisticated and adaptive platform for negotiation skill development.

### FIELD OF THE INVENTION

The present invention relates to computer-implemented methods, specifically to systems and techniques for facilitating negotiation skill development and value maximization in an AI-powered virtual negotiation environment.

### BACKGROUND OF THE INVENTION

Negotiation skills are crucial in various professional and personal contexts. Conventional methods of training lack real-world dynamics, making it challenging for users to develop effective negotiation strategies. The invention addresses this by providing a computer-implemented method that leverages AI technology to simulate realistic negotiation scenarios, offering personalized feedback, and enhancing user performance.

### SUMMARY OF THE INVENTION

In general, the invention provides a computer-implemented method for negotiation skill development and value maximization in an AI-powered, preferably virtual negotiation environment. The method comprises multiple steps, including providing access to a negotiation platform, offering diverse negotiation scenarios, enabling user registration and profile management, simulating negotiation behavior through an AI-powered virtual agent, offering real-time suggestions, evaluating performance, implementing data security measures, seamless integration with web and mobile platforms, utilizing a machine learning framework, generating suggestion prompts, implementing data management systems, and designing an API layer.

In greater particularity, the present invention relates to a computer-implemented method for enhancing negotiation skills and value outcomes within an A/I powered virtual environment. Key features of the method include a versatile negotiation platform accessible via web and mobile applications, powered by an advanced A/I system. Users are presented with a variety of real-world negotiation scenarios, ranging from predefined to customizable, catering to different expertise levels. The platform supports user account management, social media integration for sharing achievements, and employs an AI virtual agent with natural language processing for realistic negotiation simulations. The method offers dynamic suggestions to promote beneficial negotiation outcomes, evaluates user performance with detailed feedback, and adheres to strict data security and privacy standards.

Further, the platform is optimized for seamless integration with web and mobile technologies, utilizes machine learning to enhance the AI agent's interactions, and supports continuous learning through reinforcement learning. Suggestion prompts are generated and refined based on the negotiation context, ensuring the system's effectiveness and scalability. Data management is robust, with versioning systems for datasets, ongoing model monitoring, and ethical use considerations. Lastly, the method includes a comprehensive API layer for efficient communication between the negotiation platform and the language model engine, with thorough documentation for its interfaces.

Additional features of the computer-implemented negotiation training method include: a) an engaging user interface on the negotiation platform with interactive and graphical elements, virtual negotiation spaces, and dynamic feedback mechanisms for an immersive experience; b) a wide array of negotiation scenarios tailored, for example, to different industries, geographic regions, and cultural contexts, fostering adaptability in various negotiation environments.

Also provided is a recommendation engine using machine learning to dynamically propose personalized training and exercises, informed by the user's past performance, areas needing improvement, and personal negotiation style, as well as a performance evaluation module providing detailed reports featuring statistical analysis, graphical data, and benchmarks for comprehensive user feedback.

The sentiment analysis within the AI virtual agent's capabilities, allows it to respond to the emotional tone of the user, creating a positive and educational interaction. As part of said sentiment analysis, an optional virtual reality interface that gives users the opportunity to practice negotiations in a more realistic and engaging VR setting is included.

Preferably, high-standard data security measures, including end-to-end encryption, secure data storage, and regular security assessments to prevent vulnerabilities are included as well as an API layer that supports external integrations, enabling third-party developers to build custom additions to the negotiation platform.

Lastly, the system provides a continual learning protocol for the language model engine, incorporating user interaction, feedback, and current negotiation trends to keep the virtual agent current and adaptive.

### BRIEF DESCRIPTION OF THE FIGURES

The various exemplary embodiments of the present invention, which will become more apparent as the description proceeds, are described in the following detailed description in conjunction with the accompanying drawings, in which:

FIG. 1 provides a diagram of the negotiation improvement system herein;

FIG. 2 provides a process flow diagram of the negotiation improvement system herein; and

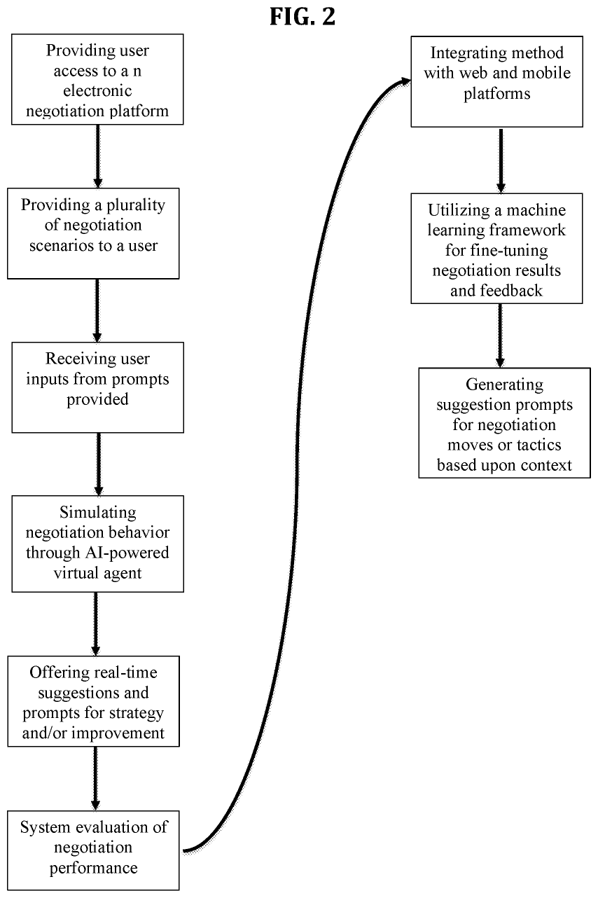

FIG. 3 provides an exemplary rendering of the user interface of the interactive user device of FIG. 1.

### DETAILED DESCRIPTION OF THE INVENTION

The following description is provided as an enabling teaching of the present systems, and/or methods in its best, currently known aspect. To this end, those skilled in the relevant art will recognize and appreciate that many changes can be made to the various aspects of the present systems, and/or methods described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a”, “an” and “the” include plural referents unless the context clearly dictates otherwise. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can”, “could”, “might”, or “may”, unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods.

Thus, if there are a variety of additional steps that can be performed it is understood that each of these additional steps can be performed with any specific aspect or combination of aspects of the disclosed methods.

The invention discloses a computer-implemented method designed to facilitate the development of negotiation skills and maximize value within an AI-powered virtual negotiation environment. The method encompasses a series of steps, starting with providing users access to a negotiation platform through web applications and mobile devices, utilizing an AI system. It further involves offering diverse negotiation scenarios, including pre-defined and customizable options that simulate real-world challenges.

Users can register, log in, manage profiles, and share achievements through integration with social media platforms. The negotiation process is simulated using an AI-powered virtual agent endowed with natural language processing capabilities, providing context-specific responses influenced by user inputs and negotiation tactics. Real-time suggestions tailored to enhance value realization are offered based on historical data, negotiation strategies, and best practices.

Evaluation of negotiation performance includes assessing individual achievements, total value for both parties, and feedback on strategies and decision-making. The method prioritizes robust data security measures, compliance with data protection regulations, and transparent privacy policies. Seamless integration with web and mobile platforms, compatibility with various browsers and devices, cloud-based hosting, and regular updates are ensured.

A machine learning framework integrates and fine-tunes an open-source large language model, facilitating parsing and understanding of user inputs, managing dialogues, and training the virtual agent using reinforcement learning techniques. Suggestion prompts for negotiation moves are generated, evaluated, and deployed on scalable cloud-based infrastructure. Data management systems, versioning, and model monitoring ensure continuous improvement and ethical considerations.

The invention also includes a visually immersive user interface, offering graphical representations of negotiation scenarios, virtual rooms, and dynamic feedback displays. Industry-specific, geographic-specific, and culturally diverse negotiation scenarios enhance user adaptability. The negotiation platform incorporates a machine learning-driven recommendation engine suggesting personalized training modules based on historical performance and identified areas for improvement.

Evaluation of negotiation performance includes generating comprehensive reports with statistical analyses, graphical representations, and comparative data against benchmarks. The AI-powered virtual agent's natural language processing capabilities include sentiment analysis for a positive learning environment. A virtual reality interface option allows users to engage in negotiation scenarios through VR devices. Data security measures comprise end-to-end encryption, secure storage protocols, and regular security audits.

The API layer facilitates integration with external platforms, enabling third-party developers to create custom modules. The language model engine's training process involves continuous learning from user interactions, feedback, and evolving negotiation trends to ensure adaptability to dynamic landscapes.

Machine learning is a branch of artificial intelligence (A/I) and computer science that focuses on the use of data and algorithms to imitate the way that humans learn, gradually improving its accuracy. Machine learning works upon data received from benchmark data module 120 by artificial intelligence engine 130. Machine learning herein can be described as the use and development of computer systems that are able to learn and adapt without following explicit instructions, by using algorithms and statistical models to analyze and draw inferences from patterns in data.

Herein, machine learning uses one or more algorithms or a series of algorithms that perform all of the following functions: 1) forms one or more data sets from the collected location data; 2) produces an estimate about a pattern in the data set; 3) makes one or more predictions about the one or more data set 4) rigorously and redundantly evaluates the one or more predictions statistically; and 5) optimizes the prediction(s) for statistical accuracy and adjusts accordingly where necessary.

Even more specifically, machine learning operates in three key ways as follows. First, a decision process occurs in which machine learning algorithms are used to make a prediction or classification. Based on some input data, which can be labelled or unlabeled, the algorithm then produces an estimate about one or more patterns in all provided data herein.

Herein, the term “prediction” refers to the output of an algorithm after it has been trained on a historical dataset and applied to new data when forecasting the likelihood of a particular outcome, such as a likely outcome of employee response to no action, mitigating action, incentives or other actions taken by an organization now armed with data from artificial intelligence engine 130 herein.

In practice, machine learning herein uses predictive optimization technology as part of its overall machine learning analysis. Predictive optimization technology is a universal technology that implements decision making, planning and decisions based upon prediction of future outcomes by means of artificial intelligence (A/I).

Second, an error function within the algorithm is provided that serves to evaluate the prediction of the model. If there are known examples, an error function can make a comparison to assess the accuracy of the model formed from artificial intelligence engine 140.

Third, a model optimization process is provided in which statistical weights are adjusted in the historical data (i.e., as created by the machine learning algorithms herein) sets to reduce the discrepancy between the known example and the model estimate. The algorithm may be programmed to repeat this evaluate and optimize process, updating weights autonomously until a requisite threshold of accuracy has been met. This threshold of accuracy is not arbitrary. It is chosen by the operator of negotiation system 100 herein and should correlate closely to the degree of accuracy required depending upon the subject industry, profession, goals, objectives, desired end results and more.

Alternatively, negotiation system 100 herein may use deep learning (DL) in addition to or instead of machine learning. The way in which deep learning and machine learning differ is in how each algorithm learns. Deep learning automates much of the feature extraction portion of the process, eliminating some of the manual human intervention required and enabling the use of larger data sets. Deep learning is often referred to as “scalable machine learning”.

Deep learning can leverage labeled datasets, also known as supervised learning, to inform its algorithm, but it doesn't necessarily require a labeled dataset. It can ingest unstructured data in its raw form (e.g., text and images), and it can automatically determine the set of features that distinguish different categories of data from one another. Unlike machine learning, it doesn't require human intervention to process data thereby allowing the negotiation system 100 to scale the use of machine learning.

Performance evaluation module 140 uses artificial intelligence algorithms and dynamic probability models to make predictions about employee performance and provide suggestions for employee performance mitigation, incentivization and/or correction (e.g., initiating a employee performance improvement plan).

Artificial Intelligence (A/I) is a branch of computer science that deals with the creation of intelligent agents or systems that can mimic human-like cognitive abilities, such as learning, reasoning, problem-solving, perception, and decision-making. A/I encompasses a wide range of techniques and algorithms, including machine learning, deep learning, natural language processing, computer vision, robotics, and more.

A/I systems leverage data and algorithms to learn patterns and make predictions or decisions without being explicitly programmed for each specific task. Machine learning, a key subset of A/I, often employs probability models to infer patterns and relationships in data and to make informed decisions and predictions.

Dynamic probability modelling and artificial intelligence are closely related concepts, as both play important roles in understanding and predicting complex systems. A dynamic probability model is a mathematical framework used to describe and analyze systems that change over time. It is a probabilistic model that calculates the uncertainty and variability inherent in dynamic processes, conditions and systems. Such models are often employed in various fields, including statistics, engineering, finance, and are useful for the negotiation system 100 herein.

The relationship between dynamic probability models (i.e., the algorithms therefor) and A/I algorithms provided by performance evaluator module 140 are multi-fold. Within the dynamic probability modeling provided in this invention are four critical functions which are the following: a) predictive analysis; b) time series analysis; c) reinforcement learning; and d) uncertainty modeling.

Predictive analysis, also known as predictive modeling, is a key feature of dynamic probability modeling in which historical data and statistical techniques are used to make predictions about future events or outcomes. The goal of predictive analysis is to identify patterns in past data and use those patterns to make informed predictions about what might happen next.

In general, predictive analysis comprises the steps of a) data collection and preparation; b) feature selection and engineering (i.e., identifying which variables or features—these terms are interchangeable—are most relevant to a given prediction task); c) model selection (i.e., the choosing of one or more algorithms to build predictive models, such as linear regression, decision trees, random forests, support vector machines, and/or neural networks); d) training the model(s); e) validation and evaluation; f) model tuning (i.e., the process of setting how the model learns); g) prediction (i.e., once the model is trained and validated, the model produces a prediction of one or more future outcomes as set by the desired features); and h) continuous monitoring and maintenance of the model.

Dynamic probability models are often used in A/I for predictive analytics tasks. In general, A/I systems can learn from historical data and capture the dynamics of a system using dynamic probability models. These models can then be used to forecast or predict future outcomes or behavior.

Many real-world problems involve time-dependent data, such as stock prices, weather patterns, or traffic flow. Dynamic probability models, such as hidden Markov models, dynamic Bayesian networks, or state-space models, are commonly used in A/I to analyze and to make predictions. In reinforcement learning, an A/I agent learns to make decisions and take actions to achieve a goal in an environment. Dynamic probability models can be used to represent the uncertainty in the environment and help the agent estimate the best actions to take in different situations.

With respect to uncertainty modeling, A/I systems often encounter uncertainty due to incomplete or noisy data. Dynamic probability models enable A/I systems to reason under uncertainty and provide accurate, high-value probabilistic estimates of outcomes, which can lead to more robust and reliable decision-making.

Overall, the relationship between dynamic probability (DP) models and A/I is symbiotic with A/I providing the raw computing power and robust calculation strength while DP provides the statistical means for feature insight and reliable predictions. Dynamic probability models provide the foundation for handling uncertainty and temporal dependencies in A/I systems, making them more adaptable, accurate, and capable of dealing with real-world complexity. On the other hand, A/I techniques leverage dynamic probability models to create intelligent systems that can effectively model and predict dynamic processes. In a dynamic probability model, the parameters or states of the system are represented as random variables, and the model captures how these variables evolve over time based on probabilistic rules. By incorporating probabilities and uncertainties, dynamic probability models allow for more realistic and flexible representations of real-world phenomena that exhibit temporal patterns or changes.

These computer program instructions may also be stored in a computer readable medium that can direct a computing device, other programmable data processing apparatus, or other devices to function in a particular manner, such that the instructions stored in the computer readable medium produce an article of manufacture including instructions that execute the function/act specified in the flowchart and/or block diagram block or blocks.

The computer program instructions may also be loaded onto a computing device, other programmable data processing apparatus, or other devices to cause a series of operational steps to be performed on the computing device, other programmable apparatus or other devices to produce a computer implemented process such that the instructions which execute on the computing device or other programmable apparatus provide processes for implementing the functions/acts specified in the flowchart and/or block diagram block or blocks.

It should be appreciated that the function blocks or modules shown in the drawings illustrate the architecture, functionality, and operation of possible implementations of systems, methods and computer program media and/or products according to various embodiments of the present invention. In this regard, each block in the drawings may represent a module, segment, or portion of code, that comprises one or more executable instructions for executing the specified logical function(s). It should also be noted that, in some alternative implementations, the functions noted in the block may occur out of the order noted in the figures. For example, the function of two blocks shown in succession may, in fact, be executed substantially concurrently, or the blocks may sometimes be executed in the reverse order, depending upon the functionality involved.

It will also be noted that each block and combinations of blocks in any one of the drawings can be implemented by special purpose hardware-based systems that perform the specified functions or acts, or combinations of special purpose hardware and computer instructions. Also, although communication between function blocks or modules may be indicated in one direction on the drawings, such communication may also be in both directions.

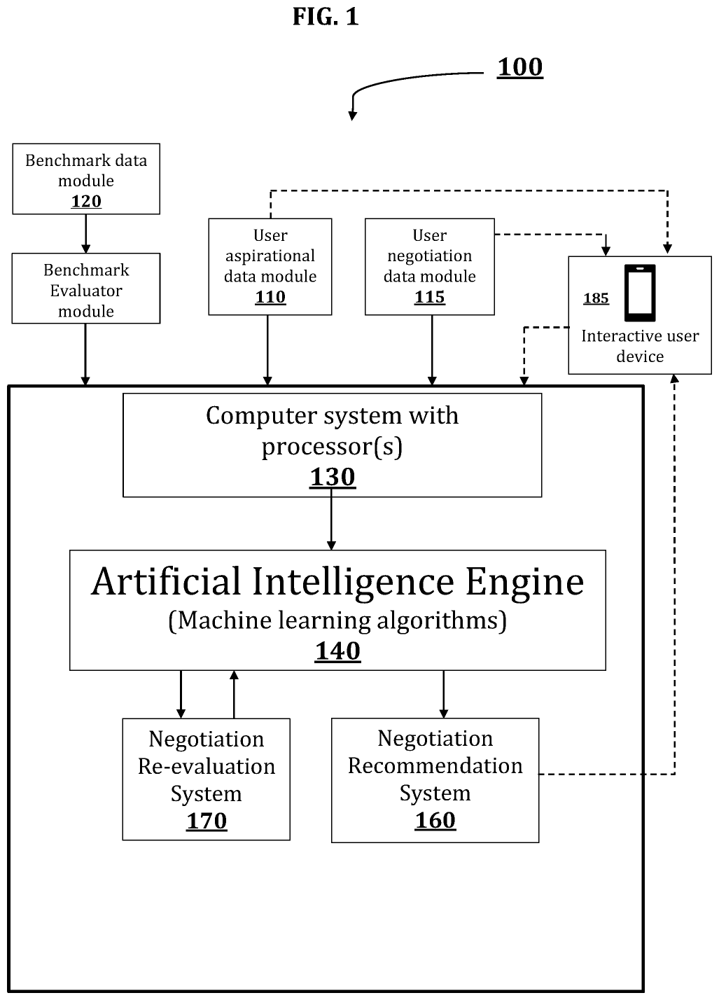

FIG. 1 provides a diagram of the enhanced negotiation improvement system 100 (or “negotiation system 100”) herein. In practice, negotiation system 100 herein comprises at least one or more server grade computers (i.e., the “server” or “fixed server”), a controller operatively connected to the computer grade server that has at least one central processing unit (i.e., CPU), static memory coupled to at least one CPU herein. The operating software by which to operate the controller, and machine learning module 130. Server grade computers of the type and kind useful for the inventive embodiments herein can be found from DELL®, IBM®, LENOVO®, HEWLETT PACKARD® and the like.

The servers herein may also be of the virtual types of server. In practice the server or servers may be exclusively virtual or a blend of virtual and hard or fixed as described immediately hereinabove. A virtual server, often referred to as a virtual private server (VPS), is a virtual machine that functions as a server. This means that it acts like a physical server but is actually a software-defined server that operates upon a physical server. The concept of virtual servers comes from virtualization technology, which allows multiple virtual servers to run on a single physical server. Each virtual server can run its own operating systems independently, and serves as a flexible, scalable, and cost-effective hosting solution for websites, applications, and services.

Processors suitable for the execution of negotiation system 100 herein include, by way of example, both general and special purpose microprocessors. Generally, a processor will receive instructions and data from read-only memory, random access memory or both. Elements of a computer can include a processor for performing actions in accordance with instructions and one or more memory devices for storing instructions and data. Generally, a computer will also include, or be operatively coupled to receive data from and/or transfer data to one or more mass storage devices for storing data, e.g., magnetic, magneto-optical disks, or optical disks.

Suitable processors for use of the kind contemplated herein include the INTEL® class of processors (i.e., CELERON®, PENTIUM®, and CORE®) and AMD® class of processors (i.e., SEMPRON®, ATHLON® and PHENOM®).

Negotiation system 100 provides multiple components for its operation. In practice, negotiation system 100 receives multiple data types. For example, multiple data modules are provided to insert certain relevant data into negotiation system 100. User aspirational data module 110 provides goal data provided by a user, the system or a third party. Also provided from user performance data module 115 is user performance data. Benchmark data module 120 provides benchmark data to system 100.

User aspirational data from user aspirational data module 110 is goal data that a user of negotiation system 100 provides or chooses one or more goals that the user wants to achieve. Negotiation system 100 provides accountability to a user providing timelines, encouragement, check-ins, and instructions to achieve the object(s) of the goal data.

User performance data from user performance data module 115 is data provided by the user (or one or more user devices) of the user's actual performance over a given time period. That time period can be as little as one day, one hour or one minute, but in any extent for as long as needed; e.g., one month, three months, five months or more, one year, several years, ten years, and the like. The time period use for performance data will be dictated by the kind of performance being assessed.

User performance data can be acquired by computer system 130 in a number of ways. Benchmark data derives from benchmark data module 120. Benchmark data module 120 may be an actual module operatively attached to computer system 130 as is shown in FIG. 1 or it is a third party source (e.g., a human resources server, athletic performance server, or the like) that can operatively communicate with negotiation system 100 via computer system 130 thereby sending requisite benchmark data thereto.

Benchmark data is data derived from a requisite industry (e.g., football (all levels), basketball (all levels), academic, industrial, and much more that serves as the standard of performance to which a user should minimally achieve to demonstrate success in a particular endeavor. Benchmark data can be the same as aspirational data, but most often serves as the baseline of user improvement from user performance data.

Benchmark data may also be data ascribed to negotiation system 100 by a user. This will arise in instances of human improvement in which a user's direct feedback to negotiation system 100 is most appropriate. An example of this happenstance might be when an athlete seeks to improve in one performance area or several. In this kind of instance when an athlete knows (or is told by a coach) what benchmarks are most appropriate; e.g., speed, agility, strength, accuracy and more, literally whatever benchmarks user decides to set.

Benchmark data can be based upon an ‘ideal user’ (i.e., a high performing user) or provide criteria of an average user or even a minimally effective user. The ideal user is preferably an agreed upon, industry-recognized user with certain agreed upon, objectively verifiable user. For example, an exemplary middle manager at the age of 30 in the consumer products industry in finance can be required to meet certain standards that are objectively measurable. Negotiation system 100 selects, but can also verify, each usable aspect of the ideal user. This benchmark data can be acquired from available industry norms and/or from the human resources of a particular organization or company. Importantly, benchmark data can (and should be) updated as benchmarks evolve and change. For purposes of negotiation system 100, benchmark data herein serves as the model data usable by artificial intelligence engine 140 herein.

In these embodiments, the sanctity of benchmark data is paramount. This is the data by which A/I engine 140 is trained, and the data that serves as the most common marker of user improvement. In either event, benchmark data must be accurate and be readily verifiable. Benchmark evaluator module 125 herein is configured to assure accuracy of the benchmark data.

Preferably, benchmark evaluator module 125 is provided for negotiation system 100. In another embodiment herein, benchmark evaluator module 125 is not provided. In that circumstance, benchmark data is collected by benchmark data module 120 and then sent directly to computer system 130 without evaluation of the accuracy thereof.

In practice, benchmark evaluator 125 can be configured to test received benchmark data by checking the accuracy thereof through digital look-ups with third party servers, websites and the like. In one embodiment herein, benchmark evaluator 125 may itself be a repository of data to which benchmark data can be compared and ultimately verified.

The interactions between user aspirational data module 110, user performance data 115 and benchmark data module 120 are several. First, they remain separable from one-another by action of computer system 130. Second, they are compared to one-another in due course of the various analyses by computer system

Interactive user inter-face 185 (also, “inter-face 185”) can be provided in the form of a handheld electronic device as demonstrated or it can be in the form of a laptop, desk top or other kind of computerized device (e.g., an Oculus headset or like computer headset of similar construction). Inter-face 185 receives information from and sends information to negotiation system 100. It enables a user to interact with negotiation system 100 and can be a source of benchmark data, user aspirational data and user performance data. User inter-face 185 is configured to receive critical information from negotiation system 100 and to track a user's progress toward achieving their self-improvement goals.

Ideally, inter-face 185 provides a graphical interface that is easy to understand, communicate with and follow. It must also be highly functional in both its receipt and tracking of data and distribution of feedback to a user. Multiple measurables will preferably appear in the graphical interface that include, but are not limited to benchmark data, improvement data, performance feedback, time remaining to reach a goal, feedback enabling reaching a goal, aspirational data, awards, rewards, incentives, ads in line with a user's goals, related apps connected to the graphical interface and much more.

Data fed into negotiation system 100 comes from user aspirational data module 110, user performance data 115, and benchmark data module 120. Each data module herein feeds data directly into computer system 130 or into interactive user device 185 which itself sends data to and receives data from negotiation system 100. The source of data for each module 110, 115 and 120 may come from direct user input, a third party data source, and/or a separate blockchain system.

Benchmark data from benchmark data 120 and/or user performance data from user performance data module 115 may each serve as model data for use by the machine learning algorithms of artificial intelligence engine 140. Data modeling in negotiation system 100 herein includes data collection, data processing, feature selection/extraction, data split, model selection, model training, model evaluation, hyperparameter tuning, final model, deployment and monitoring and maintenance.

For data collection, the first step in data modeling is to gather and collect the relevant data. This data can come from various sources, such as databases, spreadsheets, sensors, or web scraping, depending upon the problem a user or owner of negotiation system 100 seeks to solve.

For data processing, raw data is often messy and noisy. Data preprocessing involves cleaning and transforming the data into a suitable format for modeling. This step may include handling missing values, removing outliers, and encoding categorical variables.

For feature selection and extraction, one decides which features (attributes or variables) are relevant to your machine learning problem. Feature selection involves choosing a subset of the most important features, while feature extraction involves creating new features based on the existing ones. This process helps reduce dimensionality and improve model performance.

In the data split, the dataset is typically split into two or more subsets: a training set (i.e., benchmark data), a validation set, and a test set. The training set is used to train the machine learning model, the validation set is used to tune hyperparameters and assess model performance during training, and the test set is reserved for evaluating the final model.

For model selection, an appropriate machine learning algorithm based on the nature of the problem (e.g., classification, regression, clustering) and the characteristics of the data. In model training, the selected machine learning algorithm learns the patterns and relationships within the data. It optimizes its internal parameters to make accurate predictions.

In critical model evaluation, the model's performance is assessed using the validation set. Metrics such as accuracy, precision, recall, F1 score, and mean squared error are often used to measure how well the model is performing, those very same metrics being useful for the correction of the model if or when it is determined to be insufficient.

Hyperparameter tuning adjusts the hyperparameters of the machine learning algorithm to optimize the model's performance on the validation set. Techniques like cross-validation can help in this process. Once the model has been fine-tuned and validated, it can be tested on the separate test dataset to assess its generalization performance. This helps ensure that the model is not overfitting, which means it has learned the training data too well and may not perform well on new, unseen data-the final model.

If the model meets the desired performance criteria, it can be deployed for making predictions on new, real-world data, i.e., the deployment phase. For monitoring and maintenance, machine learning models require monitoring in production to ensure they continue to perform well. This may involve retraining the model with new data or adjusting as the data distribution changes.

With new data, for example, new performance data from user performance data module 115, the model may be retrained to increase its accuracy and relevancy. Such retraining is necessary to maintain the integrity of performance recommendation system 160, and performance re-evaluation system 170.

Modeling data serves several important purposes in the context of data analysis, machine learning, and statistics. Key functions and goals of data modeling include 1) pattern recognition; 2) predictive analysis; 3) hypothesis testing; 4) decision making; 5) anomaly detection; 6) optimization; 7) segmentation; 8) understanding relationships; 9) visualization and 10) generalization.

Pattern recognition in data modeling helps identify and understand patterns, relationships, and structures within a dataset-e.g., benchmark data or user performance data. It enables a system to discover otherwise hidden insights and associations that might not be apparent in the raw data.

Predictive analysis is one of the primary purposes of data modeling which creates predictive models necessary for negotiation system 100 to make highly accurate educated guesses about a user's personal performance. By building mathematical or computational representations of the data, negotiation system 100 makes predictions about future or unseen data points specifically as it relates to human performance in a given area.

In hypothesis testing, data modeling can be used to test hypotheses or theories about a particular phenomenon. Statistical models, for instance, can help determine whether observed differences in data are statistically significant. Statistical significance helps determine data accuracy which is a key feature in negotiation system 100 herein.

Negotiation system 100 is configured, by use of A/I engine 140 herein, to make decisions related to human performance and self-improvement. System decision making using data models herein can provide valuable information for decision-making processes. Such work enables users of negotiation system 100 to make informed choices, optimize processes, and allocate resources effectively based on data-driven insights about the user's performance.

Anomaly detection in data modeling is used to identify outliers or anomalies in a dataset. Such detection is important for detecting fraud, errors, or unusual behavior in various domains, such as cybersecurity or quality control or as here, human performance improvement. The negotiation system 100′s ability to detect and ultimately root out anomalies strengthens the accuracy of the data and performance improvement results overall.

Once anomalies are detected, negotiation system 100 optimization can begin. In practice, an optimization step is used in data modeling to optimize processes and systems by identifying the best combination of parameters or factors to achieve a desired outcome, and in this case, a desired outcome for advancing human performance. For instance, it can help in supply chain optimization, route planning, or resource allocation.

Data modeling herein can also be used to segment a dataset into different groups or clusters. When multiple kinds of data are received by negotiation system 100 (e.g., athletic, academic, occupational, and more), that data can be segmented and grouped by negotiation system 100 into multiple distinct data groups for organization, understanding and later data treatment. This is useful for market segmentation in marketing, customer profiling, and personalized recommendations for human performance improvement.

Additional treatment of procured data herein enables critical analysis thereof to the effect of understanding the relationships discovered therein. It can help uncover causal or correlational relationships between variables. For example, negotiation system 100 can be configured to determine how changes in one variable affect another and quantify the strength of the relationship.

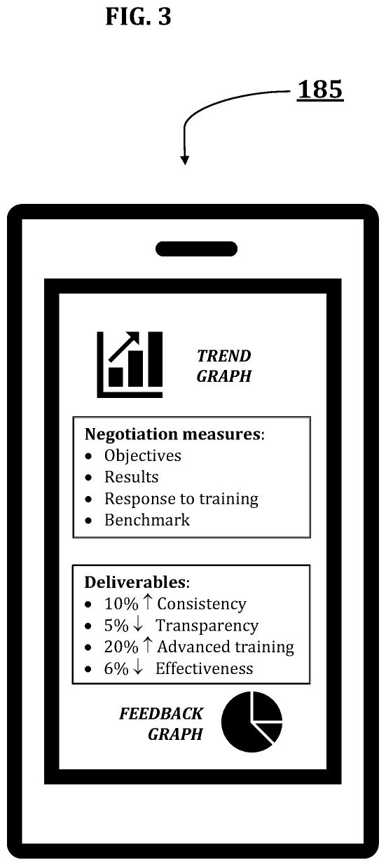

Herein, data modeling often goes hand in hand with data visualization. Models can help create visual representations of data patterns and relationships, making it easier for users to understand and interpret the data. This is a critical component of the use of data in negotiation system 100 specifically for user output formulation system 180 which feeds treated data derived from performance recommendation system 160 and performance re-evaluation system 170 to interactive user device 185. Data received by interactive user device 185 is compiled and presented to a user in readable, understandable and often graphical ways as provided for herein in the exemplary graphical model shown in FIG. 3.

In machine learning, data modeling is used to create models that generalize well—i.e., the process of generalization. This means the model herein can make accurate predictions not only on the training data but also on new, unseen data. Generalization is a critical aspect of model performance.

Generalization in machine learning refers to the ability of a trained model to make accurate predictions or perform well on new, previously unseen data that it was not explicitly trained upon. In other words, a generalized model can generalize its knowledge and learned patterns from the training data to make meaningful predictions or classifications for data it has never encountered before. This is a particularly useful attribute of negotiation system 100 herein in which multiple data types are created having to do with various types of data as noted hereinabove.

Furthermore, generalization is a fundamental concept in machine learning herein and a key measure of negotiation system 100's model performance. In practice, it reflects the model's capacity to learn underlying patterns and relationships from the training data rather than merely memorizing the data itself. The ultimate goal of training a machine learning model is to build a model that can generalize effectively to real-world, unseen data.

Data modeling includes techniques to validate the accuracy and reliability of models. This ensures that the model's predictions are trustworthy and can be used with confidence. Herein, model validation can occur within A/I engine 140, performance recommendation system 160 and/or performance re-evaluation system 170. Where such model validation occurs within negotiation system 100 is a matter of design choice and does not serve as a limitation upon the invention or any of the embodiments thereof.

To summarize, data modeling transforms raw data into structured, meaningful information, allowing organizations and individuals to gain insights, make predictions, and support decision-making processes. The specific goals and outcomes of data modeling can vary depending on the domain and the nature of the data, but the overarching aim is to leverage data for various analytical, predictive, and optimization purposes.

Importantly, user performance data module 115 should continuously receive data from a user who has engaged negotiation system 100. That data may derive from an abundance of sources including, but not limited to, manual input(s) from the user themselves, third party sources, one or more wearable devices, one or more monitoring devise (e.g., cameras, heat maps, GPS locationing systems, and/or geofences).

Artificial intelligence module 140 (or “A/I module 140”) is used herein for monitoring a user's performance toward self-improvement but doing so in a manner that learns the user, a user's tendencies, predicts a user's response or actions given certain feedback and plots paths toward a user's success using its predictive analytics and deep learning algorithms.

Artificial Intelligence (A/I) is a branch of computer science that deals with the creation of intelligent agents or systems that can mimic human-like cognitive abilities, such as learning, reasoning, problem-solving, perception, and decision-making. A/I encompasses a wide range of techniques and algorithms, including machine learning, deep learning, natural language processing, computer vision, robotics, and more.

A/I systems leverage data and algorithms to learn patterns and make predictions or decisions without being explicitly programmed for each specific task. Machine learning, a key subset of A/I, often employs probability models to infer patterns and relationships in data and to make informed decisions and predictions.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method for facilitating negotiation skill development and value maximization in an A/I powered virtual negotiation environment, comprising the following steps:
a. Providing a user with access to a negotiation platform, accessible through a web application and iOS/Android applications, said negotiation platform utilizing an A/I system;
b. Offering a plurality of negotiation scenarios, including pre-defined scenarios and customizable scenarios based on specific datasets, said scenarios designed to simulate real-world negotiation challenges and accommodating various difficulty levels;
c. Enabling user registration and login functionality, user profile management, and integration with social media platforms for achievements sharing;
d. Simulating negotiation behavior through an AI-powered virtual agent endowed with natural language processing capabilities, capable of understanding user inputs and providing context-specific responses influenced by user moves and negotiation tactics;
e. Offering real-time suggestions and prompts tailored to enhance total value realization and foster win/win outcomes, based on historical data, negotiation strategies, and best practices;
f. Evaluating negotiation performance, comprising assessment of individual objective achievement, total value accrued to both parties, and feedback on negotiation strategies, tactics, and decision-making;
g. Implementing robust data security measures, compliance with data protection regulations, anonymization of user data, and transparent privacy policies;
h. Seamlessly integrating the computer-implemented method with web and mobile platforms, ensuring compatibility with various browsers and mobile devices, deploying to cloud-based hosting infrastructure, and providing regular updates and bug fixes;
i. Utilizing a machine learning framework for integrating and fine-tuning an open-source large language model, enabling parsing and understanding of user inputs, managing negotiation dialogues, and training the virtual agent using reinforcement learning techniques;
j. Generating suggestion prompts for negotiation moves or tactics based on the negotiation context, evaluating their effectiveness, and deploying the language model on scalable cloud-based infrastructure;
k. Implementing data management and versioning systems to store, manage, and preprocess negotiation-specific datasets, along with model monitoring and maintenance procedures for continuous improvement and ethical considerations; and
l. Designing and implementing an API layer to facilitate communication between the computer-implemented method and the language model engine, with well-documented API endpoints for various functionalities.

2. The computer-implemented method of claim 1, wherein the negotiation platform's user interface provides a visually immersive experience, including interactive elements such as graphical representations of negotiation scenarios, virtual negotiation rooms, and dynamic feedback displays.

3. The computer-implemented method of claim 1, wherein the negotiation scenarios offered include industry-specific scenarios, geographic-specific scenarios, diverse languages and culturally diverse scenarios to enhance user adaptability to various negotiation contexts.

4. The computer-implemented method of claim 1, wherein the negotiation platform further comprises a machine learning-driven recommendation engine that suggests personalized training modules and exercises based on the user's historical performance, identified areas for improvement, and individual negotiation style.

5. The computer-implemented method of claim 1, wherein the evaluation of negotiation performance includes generating a comprehensive performance report for users, incorporating statistical analyses, graphical representations, and comparative data against benchmark performances.

6. The computer-implemented method of claim 1, wherein the AI-powered virtual agent's natural language processing capabilities include sentiment analysis to gauge the emotional tone of user inputs and adapt its responses to foster a positive and constructive learning environment.

7. The computer-implemented method of claim 1, further comprising a virtual reality (VR) interface option, allowing users to engage in negotiation scenarios through VR devices for an enhanced and immersive learning experience.

8. The computer-implemented method of claim 1, wherein the data security measures comprise end-to-end encryption for user communication, secure storage protocols for user profiles and negotiation data, and regular security audits to identify and address potential vulnerabilities.

9. The computer-implemented method of claim 1, wherein the API layer facilitates integration with external platforms, allowing third-party developers to create custom modules, extensions, or plugins for the negotiation platform.

10. The computer-implemented method of claim 1, wherein the language model engine's training process involves continuous learning from user interactions, user feedback, and evolving negotiation trends, ensuring the virtual agent remains adaptive to dynamic negotiation landscapes.
